(19) United States
(12) Patent Application Publication
(10) Pub. No.: US 2023/0011613 A1
(43) Pub. Date: Jan. 12, 2023

(54) METHOD OF TRAINING NEURAL NETWORK MODEL FOR CALCULATING LEARNING ABILITY AND METHOD OF CALCULATING LEARNING ABILITY OF USER

(71) Applicant: RIIID INC., Seoul (KR)

(72) Inventor: Hyun Bin LOH, Seoul (KR)

(73) Assignee: RIIID INC., Seoul (KR)

(21) Appl. No.: 17/859,085

(22) Filed: Jul. 7, 2022

(30) Foreign Application Priority Data
Jul. 9, 2021 (KR) 10-2021-0090198

(51) Int. Cl. G06N 3/08; G06N 3/04

(52) U.S. Cl. CPC G06N 3/08; G06N 3/04

(57) ABSTRACT

Provided are a method of training a neural network for calculating a learning ability and a method of calculating a user's learning ability. The method of training a neural network includes acquiring an assessment database including data, which includes question information answered by a user at a second time point earlier than a first time point, the user's answer information to the question information, and the user's score information in a second assessment system, acquired from the second assessment system different from a first assessment system, generating an answer sequence from the assessment database by matching the answer information with the score information to prepare a training set, preparing a neural network for calculating the user's score information in the second assessment system on the basis of the answer information in the second assessment system, and training the neural network with the training set.

### CROSS-REFERENCE TO RELATED APPLICATION

This application claims priority to and the benefit of Korean Patent Application No. 2021-0090198, filed on Jul. 9, 2021, the disclosure of which is incorporated herein by reference in its entirety.

### BACKGROUND

### 1. Field of the Invention

The present invention relates to a method, device, and system for assessing a learning ability. Specifically, the present invention relates to a learning ability assessment method, device, and system for calculating a user's learning ability in a formative assessment system using the user's data acquired in a summative assessment system.

### 2. Discussion of Related Art

With the development of artificial intelligence technology, an educational technology for diagnosing a user's learning ability and recommending educational content on the basis of the diagnosis result is attracting attention. To diagnose a user's learning ability or skill, a formative assessment system and a summative assessment system are used.

According to the related art, assessing a user's learning ability involves a process in which a domain expert designs an assessment model in person, collects data obtained by assessing users through the designed assessment model, and verifies the assessment model. However, the assessment model design method according to the related art is costly because a domain expert is required. Also, the assessment model design method takes a great deal of time because a process of collecting data obtained by assessing users through a designed assessment model is essentially required.

Accordingly, a learning ability assessment method, device, and system are required for assessing a user's learning ability or skill in an improved education assessment system.

### SUMMARY OF THE INVENTION

The present invention is directed to providing a learning ability assessment method, device, and system for assessing a user's learning ability in a formative assessment system.

Objects of the present invention are not limited to that described above, and other objects which have not described above will be clearly understood by those of ordinary skill in the art from the specification and accompanying drawings.

According to an aspect of the present invention, there is provided a method of training a neural network model for calculating a learning ability, the method including acquiring an assessment database including data, which includes question information answered by a user at a second time point earlier than a first time point, user's answer information to the question information, and user's score information in a second assessment system, acquired from the second assessment system different from a first assessment system, generating an answer sequence from the assessment database by matching the answer information with the score information to prepare a training set, preparing a neural network for calculating the user's score information in the second assessment system on the basis of the answer information in the second assessment system, and training the neural network with the training set.

According to another aspect of the present invention, there is provided a method of calculating a learning ability, the method including acquiring question information in a first assessment system and a target user's answer information to questions and acquiring the target user's target score information in the first assessment system using a neural network which calculates reference user's score information in a second assessment system employing a different assessment method than the first assessment system on the basis of the reference user's answer information to the questions in the second assessment system. The neural network includes an input layer for receiving the target user's target answer information in the first assessment system, an output layer for outputting the target score information including the target user's score value in the first assessment system, and a hidden layer having a plurality of nodes connecting the input layer and the output layer. The neural network is trained by adjusting weights of the plurality of nodes with the reference user's answer information in the second assessment system and the reference user's score information in the second assessment system.

Solutions to the objects of the present invention are not limited to those described above, and other solutions which have not been described above will be clearly understood by those of ordinary skill in the art from the specification and accompanying drawings.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram schematically illustrating a learning ability assessment system according to an exemplary embodiment of the present invention;

FIG. 2 is a diagram schematically illustrating a first assessment system according to the exemplary embodiment of the present invention;

FIG. 3 is a diagram schematically illustrating a second assessment system according to the exemplary embodiment of the present invention;

FIG. 4 is a diagram illustrating operations of an assessment model training device according to the exemplary embodiment of the present invention;

FIG. 5 is a diagram illustrating operations of a user assessment device in the first assessment system according to the exemplary embodiment of the present invention;

FIG. 6 is a flowchart illustrating a method of training a neural network model according to an exemplary embodiment of the present invention;

FIG. 7 is a detailed flowchart illustrating a method of preparing a training set according to the exemplary embodiment of the present invention;

FIG. 8 is a diagram illustrating an aspect of generating an answer sequence according to an exemplary embodiment of the present invention;

FIG. 9 is a diagram illustrating an aspect of training a neural network according to an exemplary embodiment of the present invention;

FIG. 10 is a flowchart illustrating a method of assessing a target user's learning ability according to an exemplary embodiment of the present invention; and

FIG. 11 is a diagram illustrating an aspect of acquiring a target user's learning ability according to an exemplary embodiment of the present invention.

### DETAILED DESCRIPTION OF EXEMPLARY EMBODIMENTS

The above-described objects, features, and advantages of the present invention will be apparent through the following detailed description related to the accompanying drawings. Since the present invention can be modified in various ways and have various embodiments, specific embodiments will be illustrated in the drawings and described in detail.

Throughout the specification, like reference numerals basically refer to like elements. Elements having the same function within the scope of the same idea shown in the drawings of each embodiment will be described using the same reference numerals, and overlapping descriptions thereof will be omitted.

When it is determined that a detailed description of a known function or element related to the present invention may unnecessarily obscure the subject matter of the present invention, the detailed description will be omitted. Also, numerals (e.g., first and second) used in the description of the specification are merely identifiers for distinguishing one element from another.

The suffixes “module” and “unit” for elements used in the following embodiments are given or interchangeably used in consideration of only the ease of drafting the specification and do not have a meaning or role distinct from each other.

In the following embodiments, the singular forms are intended to include the plural forms as well unless the context clearly indicates otherwise.

The terms “comprises,” “comprising,” “includes,” “including,” “has,” “having,” etc. mean the presence of features or elements stated herein and do not preclude the possibility of adding one or more other features or elements.

In the drawings, the sizes of elements may be exaggerated or reduced for the convenience of description. For example, the size and thickness of each element shown in the drawings are arbitrarily shown for the convenience of description, and thus the present invention is not necessarily limited to those shown in the drawings.

When a certain embodiment can be implemented differently, a specific process may be performed in a different order than that described. For example, two processes described in succession may be performed substantially simultaneously or performed in a reverse order of that described.

In the following embodiments, when elements and the like are referred to as being connected, the elements may be directly connected or indirectly connected with elements interposed therebetween.

For example, when elements and the like are referred to as being electrically connected herein, the elements and the like may be directly and electrically connected or may be indirectly and electrically connected with an element and the like interposed therebetween.

A method of training a neural network model for calculating a learning ability according to an exemplary embodiment of the present invention may include an operation of acquiring an assessment database including data, which includes question information answered by a user at a second time point earlier than a first time point, the user's answer information to the question information, and the user's score information in a second assessment system, acquired from the second assessment system different from a first assessment system, an operation of generating an answer sequence from the assessment database by matching the answer information with the score information to prepare a training set, an operation of preparing a neural network for calculating the user's score information in the second assessment system on the basis of the answer information in the second assessment system, and an operation of training the neural network with the training set.

In the method, the neural network may include an input layer for receiving the answer sequence, an output layer for outputting a result representing a score value, and a hidden layer having a plurality of nodes connecting the input layer and the output layer.

In the method, the operation of training the neural network may include an operation of inputting the answer sequence to the input layer using the training set, an operation of acquiring a score value output through the output layer, and an operation of adjusting weights of the plurality of nodes on the basis of a difference between the score value and the score information included in the answer sequence.

In the method, the operation of preparing the training set may include acquiring the answer information including an answer set from the assessment database, acquiring the score information related to the answer set, and generating a sequence by matching at least one piece of answer data included in the answer set with the score information.

In the method, the at least one piece of answer data may be randomly selected from among the pieces of answer information included in the answer set.

A method of calculating a learning ability according to an exemplary embodiment of the present invention may include an operation of acquiring question information in a first assessment system and a target user's answer information to questions and an operation of acquiring the target user's target score information in the first assessment system using a neural network which calculates a reference user's score information in a second assessment system employing a different assessment method than the first assessment system on the basis of the reference user's answer information to the questions in the second assessment system. The neural network may include an input layer for receiving the target user's target answer information in the first assessment system, an output layer for outputting the target score information including the target user's score value in the first assessment system, and a hidden layer having a plurality of nodes connecting the input layer and the output layer. The neural network may be trained by adjusting weights of the plurality of nodes with the reference user's answer information in the second assessment system and the reference user's score information in the second assessment system.

An exemplary embodiment of the present invention may provide a computer-readable recording medium on which a program for performing the method of training a neural network model for calculating a learning ability is recorded.

An exemplary embodiment of the present invention may provide a computer-readable recording medium on which a program for performing the method of calculating a learning ability is recorded.

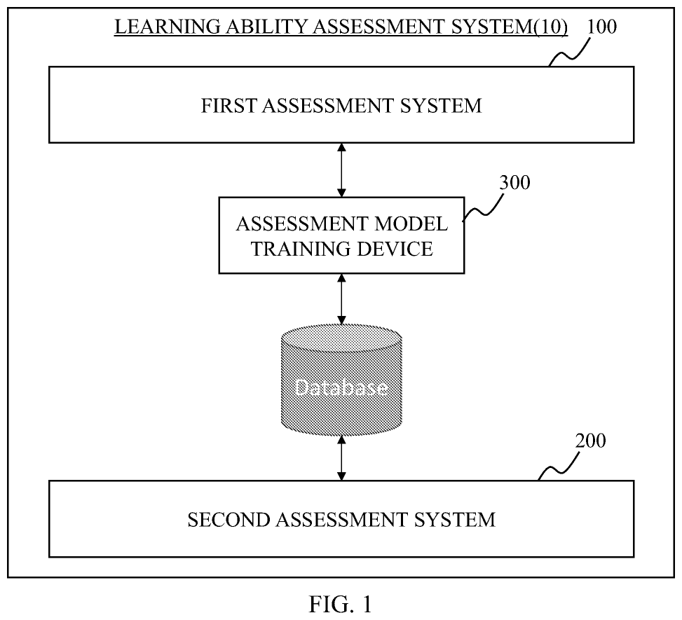

Hereinafter, a learning ability assessment method, device, and system of the present invention will be described with reference to FIGS. 1 to 11.

FIG. 1 is a block diagram schematically illustrating a learning ability assessment system 10 according to an exemplary embodiment of the present invention. The learning ability assessment system 10 according to the exemplary embodiment of the present invention may include a first assessment system 100, a second assessment system 200, an assessment model training device 300, and a database.

The first assessment system 100 may be a system for assessing a user's learning ability in real time in response to answers to questions. For example, the first assessment system 100 may be a formative assessment system. A formative assessment system may encompass any form of learning assessment system that is used for checking a student's progress in an ongoing learning process and improving the curriculum or teaching method as necessary. As an example, in a formative assessment system, providing educational content may be personalized, and thus, educational content which maximizes educational effects for each individual user may be provided. In particular, in a formative assessment system, a real-time assessment of a user may be made on the basis of a learning log of provided educational content simultaneously with the user's learning.

The second assessment system 200 may be an education assessment system that employs a different assessment method than the first assessment system 100. For example, the second assessment system 200 may be a summative assessment system. A summative assessment system may encompass any form of learning assessment system that is used for assessing the effectiveness of education at the “end” stage of a large learning unit, curriculum, or an educational program.

In a formative assessment system, it is necessary not only to provide educational content so that educational effects to users may be maximized but also to assess the users' learning abilities or skills in real time to assess the educational effects. However, creating a user assessment model in a formative assessment system involves a process in which an expert (e.g., a domain expert) personally designs an assessment model and a process of collecting data obtained by assessing users' learning abilities in real time using the assessment model designed by the expert and verifying the designed assessment model on the basis of the data. Therefore, the method of designing a user assessment model according to the related art is limited in terms of cost and time.

The learning ability assessment system 10 according to the exemplary embodiment of the present invention may design a user assessment model that is applicable to a formative assessment system using data acquired from a summative assessment system. Specifically, the learning ability assessment system 10 according to the exemplary embodiment of the present invention may acquire an assessment database including question information answered by a user, the user's answer information to the question information, and the user's score information of the second assessment system 200 acquired from the second assessment system 200. Also, the learning ability assessment system 10 may generate an answer sequence from the assessment database and train a user assessment model that is applicable to the first assessment system 100. The trained user assessment model may be applied to the first assessment system 100 to assess a user's learning ability or skill in real time according to the user's answer to a question related to the first assessment system 100.

The learning ability assessment system 10 according to the exemplary embodiment of the present invention does not involve the intervention of an expert and can design a user assessment model that is applicable to a formative assessment system without collecting formative assessment data. Accordingly, the learning ability assessment system 10 is advantageous in terms of cost and time.

Meanwhile, in FIG. 1, the assessment model training device 300 is shown separately from the first assessment system 100, the second assessment system 200, and the database, but this is merely exemplary for the convenience of description. For example, the assessment model training device 300 may be integrated with a user assessment device 120 of the first assessment system 100, an educational content recommendation device 220 of the second assessment system 200, etc.

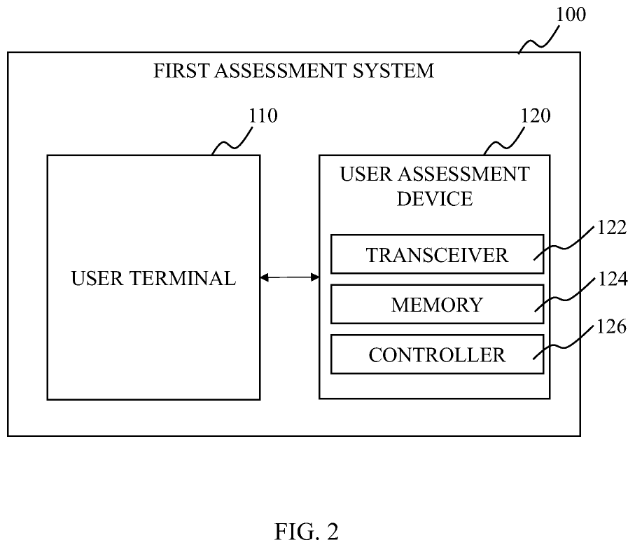

FIG. 2 is a diagram schematically illustrating the first assessment system 100 according to the exemplary embodiment of the present invention.

The first assessment system 100 according to the exemplary embodiment of the present invention may include a user terminal 110 and the user assessment device 120. As described above, the first assessment system 100 may be a system that assesses a user's learning ability in real time according to the user's answer to a question. For example, the first assessment system 100 may be a formative assessment system.

The user terminal 110 may acquire educational content from the user assessment device 120 or any external device. For example, the user terminal 110 may receive educational content from the user assessment device 120 and display the received educational content through any output part. Subsequently, the user may input an answer to the received educational content to the user terminal 110 through any input part.

The user terminal 110 may acquire learning data on the basis of the user's answer and transmit the user's learning data to the user assessment device 120. The learning data may encompass question information answered by the user, the user's answer information, correct and incorrect answer information, etc. for the question information. Meanwhile, the user terminal 110 may transmit user information to the user assessment device 120.

The user assessment device 120 according to the exemplary embodiment of the present invention may include a transceiver 122, a memory 124, and a controller 126.

The transceiver 122 may communicate with any external device including the user terminal 110, the assessment model training device 300, the database, or the second assessment system 200. For example, the user assessment device 120 may receive the learning data including the user's answer information and/or the user information from the user terminal 110 through the transceiver 122 or transmit educational content to the user terminal 110.

The user assessment device 120 may access a network through the transceiver 122 to transmit and receive various pieces of data. The transceiver 122 may be a wired type or a wireless type. Since each of the wired type and the wireless type has advantages and disadvantages, both the wired type and the wireless type may be provided in the user assessment device 120 in some cases. The wireless type may employ a wireless local area network (WLAN)-based communication method such as Wi-Fi. Alternatively, the wireless type may employ cellular communication, for example, a Long Term Evolution (LTE) or fifth generation (5G) communication method. However, a wireless communication protocol is not limited to the above-described examples, and any appropriate wireless communication method may be used. The wired type typically employs, for example, local area network (LAN) or universal serial bus (USB) communication and may also employ other communication methods.

The memory 124 may store various pieces of information. In the memory 124, various pieces of data may be temporarily or semi-permanently stored. Examples of the memory 124 include a hard disk driver (HDD), a solid state drive (SSD), a flash memory, a read-only memory (ROM), a random access memory (RAM), etc. The memory 124 may be provided in a form that is embedded in or detachable from the user assessment device 120. The memory 124 may store an operating system (OS) for operating the user assessment device 120, a program for operating each element of the user assessment device 120, and various pieces of data required for operations of the user assessment device 120.

The controller 126 may control the overall operation of the user assessment device 120. For example, the controller 126 may control an operation of acquiring target answer information from the user terminal 110 of a target user, who will be described below, an operation of acquiring a trained neural network model from an assessment model training device 300, an operation of calculating or acquiring target score information, an operation of transmitting the target score information, etc. Specifically, the controller 126 may load a program for the overall operation of the user assessment device 120 from the memory 124 and run the program. The controller 126 may be implemented as an application processor (AP), a central processing unit (CPU), or a similar device on the basis of hardware, software, or a combination of hardware and software. As hardware, the controller 126 may be provided in the form of an electronic circuit for processing an electrical signal to perform a control function. As software, the controller 126 may be provided in the form of a program or code for operating a hardware circuit.

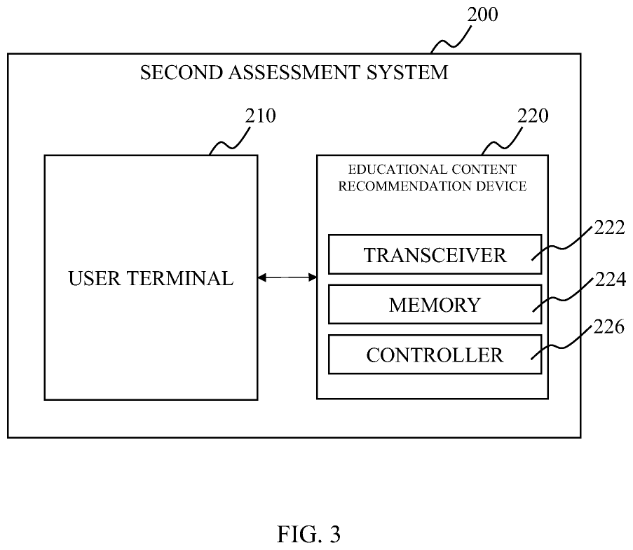

FIG. 3 is a diagram schematically illustrating the second assessment system 200 according to the exemplary embodiment of the present invention.

The second assessment system according to the exemplary embodiment of the present invention may include a user terminal 210 and the educational content recommendation device 220. As described above, the second assessment system 200 may be a system employing a different assessment method than the first assessment system 100. For example, the second assessment system 200 may be a summative assessment system.

The user terminal 210 may acquire educational content from the educational content recommendation device 220 or any external device. For example, the user terminal 210 may receive educational content from the educational content recommendation device 220 and display the received educational content through any output part. Subsequently, the user may input an answer to the received educational content to the user terminal 210 through any input part.

The user terminal 210 may acquire learning data on the basis of the user's answer and transmit the user's learning data to the educational content recommendation device 220 or the database. The learning data may encompass question information answered by the user, the user's answer information, correct and incorrect answer information, etc. for the question information. Meanwhile, the user terminal 210 may transmit user information and/or the user's score information in the second assessment system 200 to the educational content recommendation device 220.

The educational content recommendation device 220 according to the exemplary embodiment of the present invention may include a transceiver 222, a memory 224, and a controller 226.

The transceiver 222 may communicate with any external device including the user terminal 210, the assessment model training device 300, the database, or the first assessment system 100. For example, the educational content recommendation device 220 may receive the user's learning data, the user's score information, and/or the user information from the user terminal 210 through the transceiver 222 or transmit educational content to the user terminal 210.

The educational content recommendation device 220 may access a network through the transceiver 222 to transmit and receive various pieces of data. The transceiver 222 may be a wired type or a wireless type. Since each of the wired type and the wireless type has advantages and disadvantages, both the wired type and the wireless type may be provided in the educational content recommendation device 220 in some cases. The wireless type may employ a WLAN-based communication method such as Wi-Fi. Alternatively, the wireless type may employ cellular communication, for example, an LTE or 5G communication method. However, a wireless communication protocol is not limited to the above-described examples, and any appropriate wireless communication method may be used. The wired type typically employs, for example, LAN or USB communication and may also employ other communication methods.

The memory 224 may store various pieces of information. In the memory 224, various pieces of data may be temporarily or semi-permanently stored. Examples of the memory 224 include an HDD, an SSD, a flash memory, a ROM, a RAM, etc. The memory 224 may be provided in a form that is embedded in or detachable from the educational content recommendation device 220. The memory 224 may store an OS for operating the educational content recommendation device 220, a program for operating each element of the educational content recommendation device 220, and various pieces of data required for operations of the educational content recommendation device 220.

The controller 226 may control the overall operation of the educational content recommendation device 220. Specifically, the controller 226 may load a program for the overall operation of the educational content recommendation device 220 from the memory 224 and run the program. The controller 226 may be implemented as an AP, a CPU, or a similar device on the basis of hardware, software, or a combination of hardware and software. As hardware, the controller 226 may be provided in the form of an electronic circuit for processing an electrical signal to perform a control function. As software, the controller 226 may be provided in the form of a program or code for operating a hardware circuit.

The database may store any pieces of data of the learning ability assessment system 10 according to the exemplary embodiment of the present invention.

As an example, the database may store various pieces of data related to the second assessment system 200. For example, the database may store question information related to the second assessment system 200, the user's answer information to the question information, and/or the user's score information in the second assessment system 200.

As another example, the database may store various pieces of data related to the assessment model training device 300. For example, the database may store any data related to weights or parameters of nodes of a trained neural network model.

However, the above descriptions are merely exemplary, and the database may store various pieces of data related to the first assessment system 100. For example, the database may store question information related to the first assessment system 100 and/or a target user's answer information to the question information, and the stored question information and/or answer information may be used for updating a trained neural network model which will be described below.

The assessment model training device 300 according to the exemplary embodiment of the present invention may perform an operation of a model for assessing or quantifying a user's learning ability. For example, the assessment model training device 300 may train a model for quantifying the learning ability of a target user of the first assessment system 100 on the basis of data acquired from the second assessment system 200.

For example, the assessment model training device 300 may use a neural network model as a model for assessing a user's learning ability. The neural network model may be provided as a machine learning model. A representative example of the machine learning model may be an artificial neural network. Specifically, a representative example of the artificial neural network may be a deep learning-based artificial neural network including an input layer for receiving data, an output layer for outputting a result, and a hidden layer for processing data between the input layer and the output layer. Detailed examples of the artificial neural network include a convolutional neural network, a recurrent neural network, a deep neural network, a generative adversarial network, etc. In the present specification, an artificial neural network is interpreted as a comprehensive meaning that encompasses all of the above-described artificial neural network, various other forms of artificial neural networks, and artificial neural networks having a combined form of the artificial neural networks, and an artificial neural network is not necessarily based on deep learning.

Further, the machine learning model does not necessarily have the form of an artificial neural network model. In addition to an artificial neural network model, the machine learning model may employ a K-nearest neighbors (KNN) algorithm, a random forest, a support vector machine (SVM), principal component analysis (PCA), etc. Alternatively, the machine learning model may be an ensemble of the above-described techniques or may have various combined forms of the above-described techniques. Meanwhile, in exemplary embodiments described on the basis of an artificial neural network, the artificial neural network may be replaced with another machine learning model unless specifically described otherwise.

Further, in the present specification, an algorithm for assessing a target user's learning ability is not necessarily limited to a machine learning model. In other words, the algorithm for assessing a target user's learning ability may be various determination or decision algorithms other than a machine learning model. Accordingly, in the present specification, the algorithm for assessing a target user's learning ability is to be understood as a comprehensive meaning that encompasses all forms of algorithms for calculating target score information using the target user's target answer information. However, for the convenience of description, an artificial neural network model will be mainly described below.

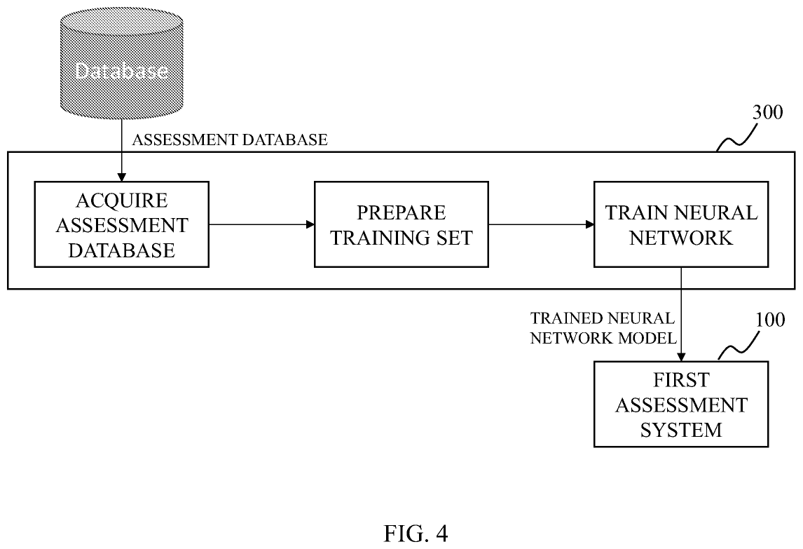

Operations of the assessment model training device 300 according to the exemplary embodiment of the present invention will be described below with reference to FIG. 4. FIG. 4 is a diagram illustrating operations of the assessment model training device 300 according to the exemplary embodiment of the present invention.

The assessment model training device 300 according to the exemplary embodiment of the present invention may acquire an assessment database from a database. The assessment database may include question information answered by a user, the user's answer information to questions, and/or the user's score information of the second assessment system 200 acquired from the second assessment system 200.

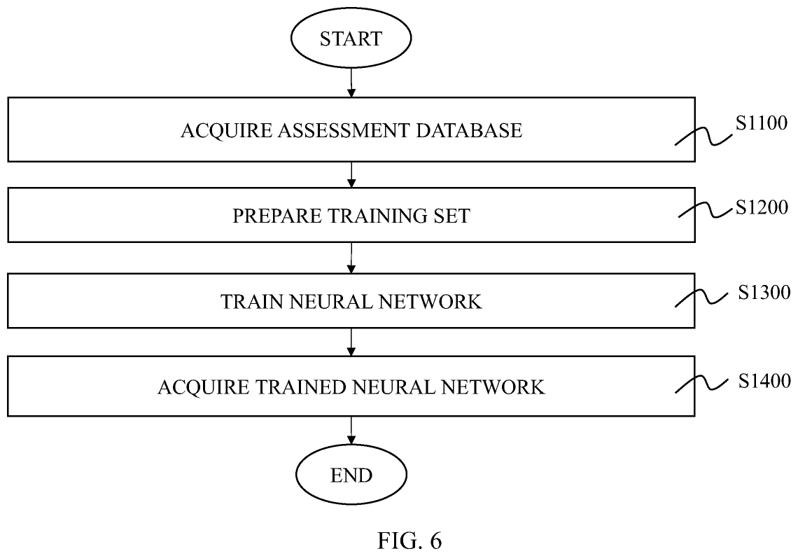

The assessment model training device 300 according to the exemplary embodiment of the present invention may be implemented to prepare a training set from the assessment database. Specifically, the assessment model training device 300 may generate an answer sequence on the basis of the question information answered by the user, the user's answer information to the question information, and/or the user's score information of the second assessment system 200 in the assessment database to prepare a training set. Details of generating an answer sequence will be described with reference to FIGS. 6 to 9.

The assessment model training device 300 according to the exemplary embodiment of the present invention may perform an operation of training a neural network model. Specifically, the assessment model training device 300 may prepare a neural network model for calculating the user's score information of the second assessment system 200 on the basis of the answer information included in the answer sequence and train the neural network model with the training set so that the user's score information is output. Details of training a neural network model will be described with reference to FIGS. 6 to 9.

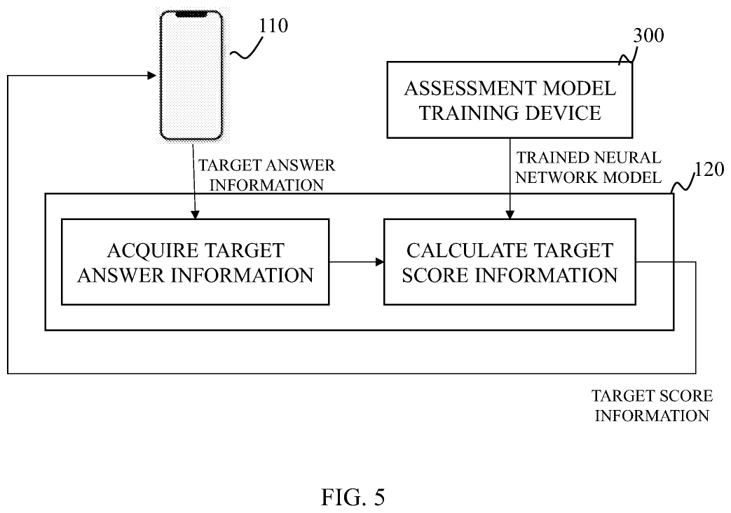

FIG. 5 is a diagram illustrating operations of the user assessment device 120 in the first assessment system 100 according to the exemplary embodiment of the present invention.

The user assessment device 120 according to the exemplary embodiment of the present invention may acquire question information related to the first assessment system 100 and a target user's target answer information to questions from the user terminal 110. The target answer information may include information on answers selected for the questions by the target user or whether the answers are correct.

The user assessment device 120 according to the exemplary embodiment of the present invention may acquire a trained neural network model or weights (or parameters) of nodes of a trained neural network model. For example, the user assessment device 120 may acquire a trained neural network model from the assessment model training device 300 or acquire weights (or parameters) of nodes included in a trained neural network model from the assessment model training device 300.

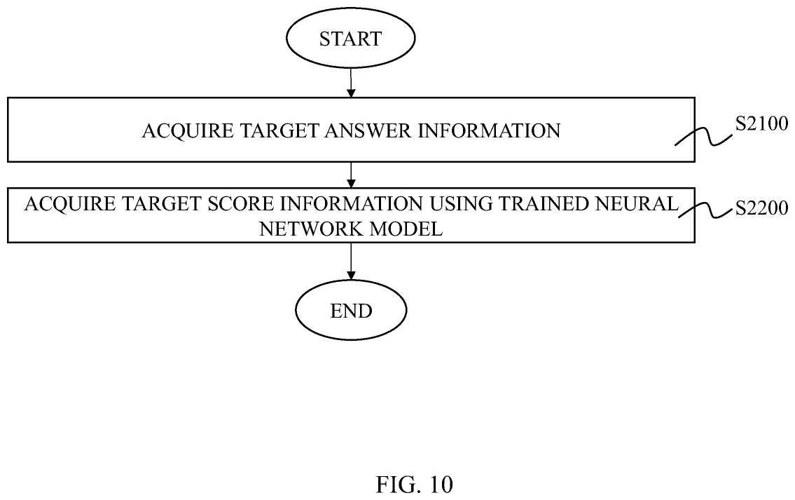

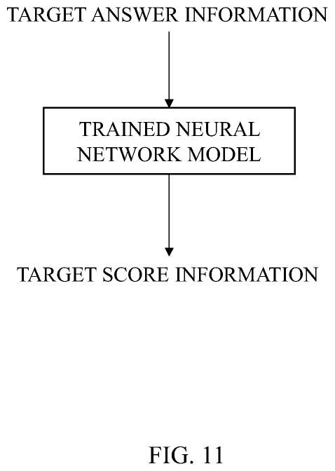

The user assessment device 120 according to the exemplary embodiment of the present invention may perform an operation of calculating or acquiring target score information on the basis of the trained neural network model and the target answer information. Specifically, the user assessment device 120 may input the target answer information to the input layer of the trained neural network model and acquire through the output layer. Details of acquiring target score information using a trained neural network will be described with reference to FIGS. 10 and 11.

The user assessment device 120 according to the exemplary embodiment of the present invention may transmit the target score information to the user terminal 110 or any external device including the database.

Meanwhile, the user assessment device 120 according to the exemplary embodiment of the present invention may update the trained neural network model on the basis of the target answer information and the target score information. For example, the user assessment device 120 may additionally update weights (or parameters) of nodes of the trained neural network model with the target answer information and the target score information. Accordingly, according to the exemplary embodiment of the present invention, an assessment model for a user's learning ability can be updated in real time.

Also, an assessment of a user's learning ability can be updated in real time. Specifically, a user's learning ability can be assessed in consideration of the user's question answering and the user's learning activity related to the question answering.

The method of training a neural network model will be described in more detail with reference to FIGS. 6 to 9. The method of training a neural network model which will be described below may be performed by the assessment model training device 300 according to the exemplary embodiment of the present invention. See FIG. 6. FIG. 6 is a flowchart illustrating a method of training a neural network model according to an exemplary embodiment of the present invention.

The method of training a neural network model according to the exemplary embodiment of the present invention may include an operation S1100 of acquiring an assessment database, an operation S1200 of preparing a training set, an operation S1300 of training a neural network model, and an operation S1400 of acquiring the trained neural network model.

In the operation S1100 of acquiring an assessment database, the assessment model training device 300 may acquire an assessment database. For example, the assessment model training device 300 may receive an assessment database from the database. The assessment database may include question information answered by a user in relation to the second assessment system 200, the user's answer information to questions, and/or the user's score information related to the second assessment system.

In the operation S1200 of preparing a training set, the assessment model training device 300 may prepare a training set by generating an answer sequence from the assessment database. For example, the assessment model training device 300 may generate an answer sequence by matching the user's answer information to questions related to the second assessment system 200 and included in the assessment database with the user's score information related to the second assessment system 200.

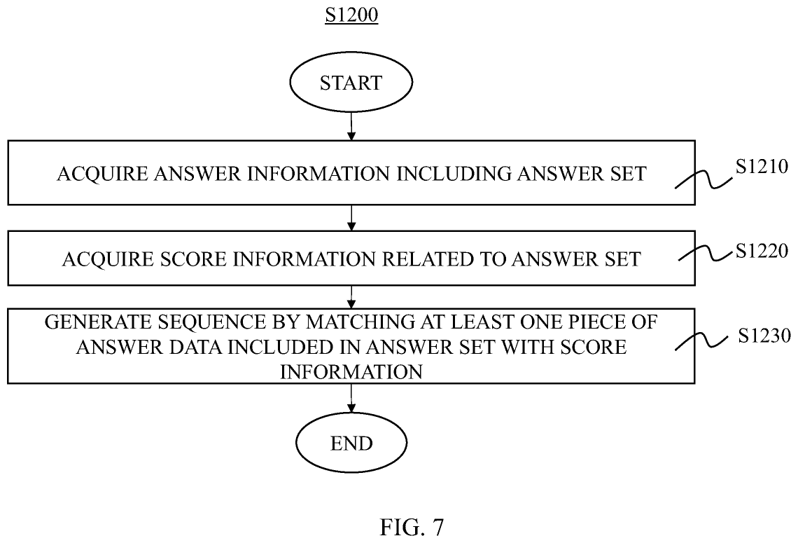

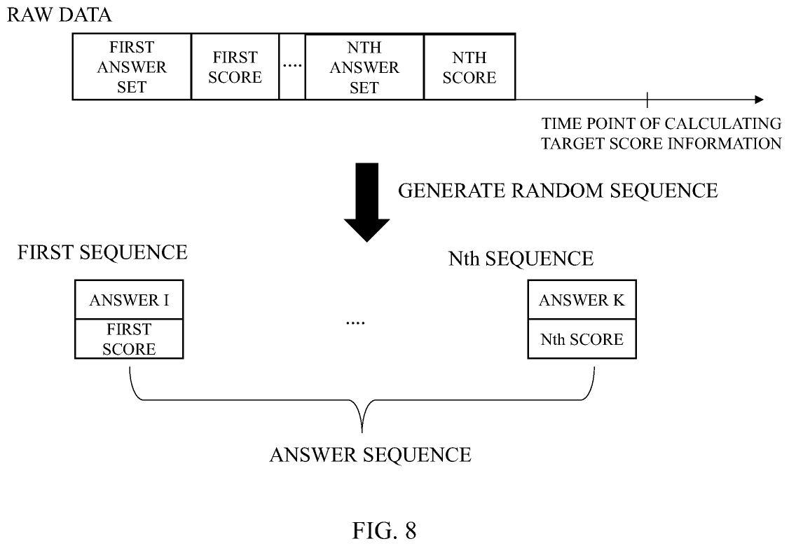

See FIGS. 7 and 8. FIG. 7 is a detailed flowchart illustrating a method of preparing a training set according to the exemplary embodiment of the present invention. FIG. 8 is a diagram illustrating an aspect of generating an answer sequence according to an exemplary embodiment of the present invention.

The operation S1200 of preparing a training set according to the exemplary embodiment of the present invention may include an operation S1210 of acquiring answer information including an answer set, an operation S1220 of acquiring score information related to the answer set, and an operation S1230 of generating a sequence by matching at least one piece of answer data included in the answer set with score information.

As described above, the assessment database acquired from the database may include question information related to the second assessment system 200, a user's answer information to questions, and/or the user's score information in the second assessment system 200. As an example, the assessment database may include a first answer set related to the user's answer to each of questions included in a first question set related to the second assessment system 200. Also, the assessment database may include score information (e.g., a first score) related to the first answer set. As another example, the assessment database may include an N^{th} answer set related to the user's answer to each of questions included in an N^{th} question set related to the second assessment system 200. Also, the assessment database may include score information (e.g., an N^{th} score) related to the N^{th} answer set.

The assessment database may include the user's answer information to questions at a time point before target score information to be described below is calculated and/or the user's score information in the second assessment system 200. For example, when a time point to be described below at which the user assessment device 120 acquires target answer information and calculates target score information is a first time point, the answer information and/or the score information included in the assessment database may correspond to a second time point which is an earlier time point than the first time point.

Meanwhile, although not shown in FIG. 7, the assessment model training device 300 may perform an operation of arranging question information related to the second assessment system 200, the user's answer information to questions, and/or the user's score information in the second assessment system 200, which are acquired from the database, on the basis of question sets. Also, the assessment model training device 300 may perform an operation of arranging question information related to the second assessment system 200, the user's answer information to questions, and/or the user's score information in the second assessment system 200, which are acquired from the database, in chronological order.

In the operation S1210 of acquiring answer information including an answer set, the assessment model training device 300 according to the exemplary embodiment of the present invention may acquire answer information including an answer set from raw data of the assessment database. As an example, the assessment model training device 300 may acquire answer information related to a first answer set from the raw data. The first answer set may include at least one piece of answer data including an answer I. As another example, the assessment model training device 300 may acquire answer information related to an N^{th} answer set from the raw data. The N^{th} answer set may include at least one piece of answer data including an answer K.

In the operation S1220 of acquiring score information related to the answer set, the assessment model training device 300 according to the exemplary embodiment of the present invention may acquire score information related to the answer set from the raw data of the assessment database. For example, the assessment model training device 300 may acquire score information (e.g., a first score) related to the first answer set. Also, the assessment model training device 300 may acquire score information (e.g., an N^{th} score) related to the N^{th} answer set.

In the operation S1230 of generating a sequence by matching at least one piece of answer data included in the answer set with score information, the assessment model training device 300 according to the exemplary embodiment of the present invention may generate a sequence by matching the answer set with score information related to the answer set. Specifically, the assessment model training device 300 may generate a sequence by matching at least one piece of answer data included in the answer set with score information related to the answer set. As an example, the assessment model training device 300 may generate a first sequence by matching at least one piece of answer data (e.g., the answer I) included in the first answer set with the score information (e.g., the first score) related to the first answer set. As another example, the assessment model training device 300 may generate an N^{th} sequence by matching at least one piece of answer data (e.g., the answer K) included in the N^{th} answer set with the score information (e.g., the N^{th} score) related to the N^{th} answer set.

Meanwhile, the assessment model training device 300 according to the exemplary embodiment of the present invention may be implemented to randomly select are combine one or more pieces of answer data included in the answer set from among the pieces of answer information included in the answer set and. As an example, one or more pieces of answer data (e.g., the answer I) used for generating the first sequence may be data randomly selected and combined from among pieces of answer information included in the first answer set. As another example, one or more pieces of answer data (e.g., the answer K) used for generating the N^{th} sequence may be data randomly selected and combined from among pieces of answer information included in the N^{th} answer set.

However, this is merely exemplary, and to prepare a sophisticated training set, the assessment model training device 300 may generate an answer sequence by matching answer information with score information using any appropriate method. Referring back to FIG. 6, the method of training a neural network model according to the exemplary embodiment of the present invention may include the operation S1300 of training a neural network model.

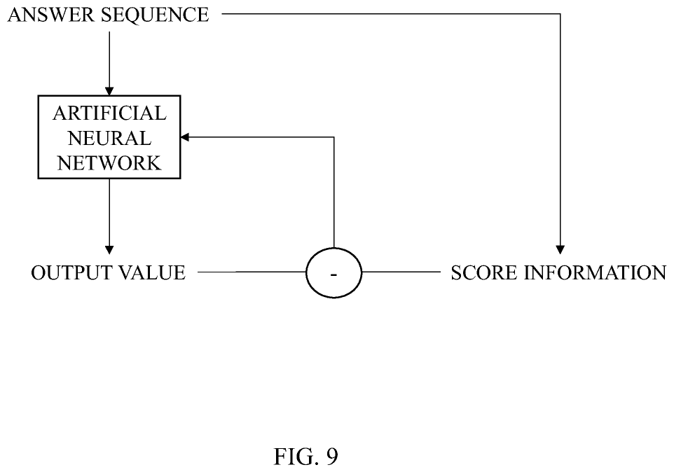

FIG. 9 is a diagram illustrating an aspect of training a neural network according to an exemplary embodiment of the present invention.

A neural network model may include an input layer, an output layer, and a hidden layer. The input layer may receive an answer sequence of the training set, and the output layer may output a result indicating a user's score value as an output value. The hidden layer may have a plurality of nodes connecting the input layer and the output layer.

The assessment model training device 300 according to the exemplary embodiment of the present invention may train a neural network to output a user's score information in the second assessment system 200 on the basis of answer information in the second assessment system 200. Specifically, the assessment model training device 300 may input an answer sequence to the input layer and acquire an output value (e.g., an expected score value in the second assessment system 200) output through the output layer. Also, the assessment model training device 300 may adjust weights (or parameters) of nodes included in the hidden layer on the basis of the difference between the user's score information of the second assessment system 200 included in the answer sequence and the output value. As an example, the assessment model training device 300 may input a first sequence to the input layer and repeatedly update the weights (or parameters) of the nodes included in the hidden layer on the basis of the difference between an output value output through the output layer and a first score included in the first sequence. As another example, the assessment model training device 300 may input an N^{th} sequence to the input layer and repeatedly update the weights (or parameters) of the nodes included in the hidden layer on the basis of the difference between an output value output through the output layer and an N^{th} score included in the N^{th} sequence.

Specifically, the assessment model training device 300 may train the neural network model by repeatedly adjusting the weights (or parameters) of the nodes included in the hidden layer so that the difference between the user's score information of the second assessment system 200 included in the answer sequence and an output value is minimized.

Referring back to FIG. 6, the method of training a neural network model according to the exemplary embodiment of the present invention may include the operation S1400 of acquiring the trained neural network model. In the operation S1400 of acquiring the trained neural network model, the assessment model training device 300 may acquire the weights or parameters of the nodes included in the hidden layer that is trained to minimize the difference between an output value output through the output layer and the user's score information included in the answer sequence. Alternatively, in the operation S1400 of acquiring the trained neural network model, the assessment model training device 300 may acquire a neural network model including a hidden layer including nodes having the above-described weights or parameters.

The acquired neural network model may be used for assessing the target user's learning ability in the first assessment system 100 (e.g., the user's score information in the first assessment system 100). For example, as described above, the first assessment system 100 may be a formative assessment system. According to the exemplary embodiment of the present invention, it is possible to acquire a user assessment model of the first assessment system 100 on the basis of the training set prepared with data acquired from the second assessment system 200, for example, a summative assessment system.

Meanwhile, although not shown in FIG. 6, the method of training a neural network model according to the exemplary embodiment of the present invention may further include an operation of verifying the neural network. For example, the assessment model training device 300 may verify the neural network model on the basis of at least a part of the answer sequence included in the training set. Specifically, the assessment model training device 300 may input at least a part of the answer sequence to the input layer of the neural network model and acquire an output value output through the output layer. Also, the assessment model training device 300 may verify whether the weights (or parameters) of the nodes included in the hidden layer of the neural network model are appropriate by comparing the output value with score information included in at least the partial sequence.

A method of assessing a target user's learning ability in the first assessment system 100 according to an exemplary embodiment of the present invention will be described in detail below with reference to FIGS. 10 and 11. The method of assessing a learning ability may be implemented by the user assessment device 120 of the first assessment system 100 according to the exemplary embodiment of the present invention.

FIG. 10 is a flowchart illustrating a method of assessing a target user's learning ability according to an exemplary embodiment of the present invention. FIG. 11 is a diagram illustrating an aspect of acquiring a target user's learning ability according to an exemplary embodiment of the present invention.

The method of assessing a target user's learning ability according to the exemplary embodiment of the present invention may include an operation S2100 of acquiring target answer information and an operation S2200 of acquiring target score information using a trained neural network model.

In the operation S2100 of acquiring target answer information, the user assessment device 120 may acquire a target user's answer information from the user terminal 110. The answer information may be, for example, information related to the target user's answer to a question related to the first assessment system 100, for example, a formative assessment system.

Meanwhile, although not shown in FIGS. 10 and 11, the user assessment device 120 may acquire a trained neural network model from the assessment model training device 300. As an example, the user assessment device 120 may acquire weights or parameters of nodes acquired when the assessment model training device 300 trains the neural network model. As another example, the user assessment device 120 may acquire a neural network including a hidden layer including nodes having weights or parameters acquired when the assessment model training device 300 trains the neural network model.

In the operation S2200 of acquiring target score information using a trained neural network model, the user assessment device 120 according to the exemplary embodiment of the present invention may acquire target score information on the basis of the trained neural network model and the target answer information. For example, the user assessment device 120 inputs the target user's target answer information related to the first assessment system 100 to the input layer of the trained neural network model and acquire target score information through the output layer. Since the trained neural network model is trained to acquire a user's score information on the basis of the user's answer information, the user assessment device 120 may acquire target score information on the basis of the trained neural network model and the target user's target answer information.

As described above, according to the exemplary embodiment, the user assessment device 120 may update the trained neural network model on the basis of the target answer information and the target score information. For example, the user assessment device 120 may adjust or update the weights (or parameters) of the nodes included in the trained neural network model on the basis of the target answer information and the target score information.

The learning ability assessment system 10 according to the exemplary embodiment of the present invention can design a neural network model that assesses a target user's learning ability or skill in the first assessment system 100 in real time and calculate the target user's target score information related to the first assessment system 100 on the basis of data related to the second assessment system 200. Accordingly, it is possible to calculate the target user's target score information in the first assessment system 100 without the intervention of an expert, and thus the learning ability assessment system 10 is less costly. Also, the learning ability assessment system 10 according to the exemplary embodiment of the present invention can design an assessment model for a user in the first assessment system 100 on the basis of data of the second assessment system 200, which employs a different assessment method than the first assessment system 100, when there is no data in the first assessment system 100.

Further, in the learning ability assessment system 10 according to the exemplary embodiment of the present invention, it is possible to train a neural network model that assesses a user's learning ability or skill in the first assessment system 100 without collecting data in the first assessment system 100,

In addition, the learning ability assessment system 10 according to the exemplary embodiment of the present invention can acquire an assessment model for updating an assessment of a user's ability in real time, and the assessment model can assess a user's learning ability in consideration of both question answering and learning activities related to the question answering.

The above-described various operations of the user assessment device 120 may be stored in the memory 124 of the user assessment device 120, and the controller 126 of the user assessment device 120 may be provided to perform the operations stored in the memory 124. Also, various operations of the educational content recommendation device 220 may be stored in the memory 224 of the educational content recommendation device 220, and the controller 226 of the educational content recommendation device 220 may be provided to perform the operations stored in the memory 224.

The method, device, and system for assessing a learning ability according to the exemplary embodiments of the present invention can calculate a user's score information in a formative assessment system.

The method, device, and system for assessing a learning ability according to the exemplary embodiments of the present invention assess a user's learning ability in a formative assessment system without an expert's intervention and thus can be less costly.

The method, device, and system for assessing a learning ability according to the exemplary embodiments of the present invention assess a user's learning ability in a formative assessment system without collecting the user's data in the formative assessment system, and thus it is possible to save the time required for data collection.

Effects of the present invention are not limited to those described above, and other effects which have not been described above will be clearly understood by those of ordinary skill in the art from the specification and accompanying drawings.

The features, structures, effects, etc. described in the exemplary embodiments are included in at least one embodiment of the present invention and are not necessarily limited to one embodiment. Further, the features, structures, effects, etc. provided in each embodiment can be combined or modified in other embodiments by those of ordinary skill in the art to which the embodiments belong. Accordingly, contents related to the combination and modification should be construed to be included in the scope of the present invention.

Although embodiments of the present invention have been described above, these are just examples and do not limit the present invention. The present invention can be modified and applied in various ways not illustrated above without departing from the essential features of the present invention by those of ordinary skill in the art. In other words, each element described in detail in the embodiments can be modified. Also, differences related to the modification and application should be construed as falling within the scope of the present invention which is defined by the accompanying claims.

What is claimed is:

1. A method of training a neural network model which calculates a learning ability and is applied to a first assessment system for assessing a learning ability of a target user in real time according to an answer of the target user at a first time point, the method comprising:
acquiring an assessment database including data, which includes question information answered by a user at a second time point earlier than the first time point, answer information of the user to the question information, and score information of the user in a second assessment system, acquired from the second assessment system different from the first assessment system;
generating an answer sequence from the assessment database by matching the answer information with the score information to prepare a training set;
preparing a neural network for calculating score information of the user in the second assessment system on the basis of the answer information in the second assessment system; and
training the neural network with the training set.

2. The method of claim 1, wherein the neural network comprises:
an input layer configured to receive the answer sequence;
an output layer configured to output a result representing a score value; and
a hidden layer having a plurality of nodes connecting the input layer and the output layer.

3. The method of claim 2, wherein the training of the neural network comprises:
inputting the answer sequence to the input layer using the training set;
acquiring the score value output through the output layer; and
adjusting weights of the nodes on the basis of a difference between the score value and the score information included in the answer sequence.

4. The method of claim 1, wherein the preparing of the training set comprises:
acquiring the answer information including an answer set from the assessment database;
acquiring the score information related to the answer set; and
generating a sequence by matching at least one piece of answer data included in the answer set with the score information.

5. The method of claim 4, wherein the at least one piece of answer data is randomly selected from among the pieces of answer information included in the answer set.

6. A method of calculating learning ability of a user in a first assessment system for assessing learning ability of a user in real time according to an answer of the user, the method comprising:
acquiring question information in the first assessment system and answer information of a target user to questions; and
acquiring target score information of the target user in the first assessment system using a neural network which calculates score information of a reference user in a second assessment system different from the first assessment system on the basis of answer information of the reference user to the questions in the second assessment system,
wherein the neural network comprises:
an input layer configured to receive the target answer information of the target user in the first assessment system;
an output layer configured to output the target score information including a score value of the target user in the first assessment system; and
a hidden layer having a plurality of nodes connecting the input layer and the output layer, and
the neural network is trained by adjusting weights of the plurality of nodes with the answer information of the reference user in the second assessment system and the score information of the reference user in the second assessment system.

7. A non-transitory computer-readable recording medium in which a computer program executed by a computer is recorded, the computer program comprising:
acquiring an assessment database including data, which includes question information answered by a user at a second time point earlier than the first time point, answer information of the user to the question information, and score information of the user in a second assessment system, acquired from the second assessment system different from the first assessment system;
generating an answer sequence from the assessment database by matching the answer information with the score information to prepare a training set;
preparing a neural network for calculating score information of the user in the second assessment system on the basis of the answer information in the second assessment system; and
training the neural network with the training set.

8. A non-transitory computer-readable recording medium in which a computer program executed by a computer is recorded, the computer program comprising:
acquiring question information in the first assessment system and answer information of a target user to questions; and
acquiring target score information of the target user in the first assessment system using a neural network which calculates score information of a reference user in a second assessment system different from the first assessment system on the basis of answer information of the reference user to the questions in the second assessment system,
wherein the neural network comprises:
an input layer configured to receive the target answer information of the target user in the first assessment system;
an output layer configured to output the target score information including a score value of the target user in the first assessment system; and
a hidden layer having a plurality of nodes connecting the input layer and the output layer, and
the neural network is trained by adjusting weights of the plurality of nodes with the answer information of the reference user in the second assessment system and the score information of the reference user in the second assessment system.
